(19) United States
(12) Patent Application Publication
(10) Pub. No.: US 2021/0114725 A1
(43) Pub. Date: Apr. 22, 2021

(54) COMPOSITE FLYING VEHICLE

(71) Applicants: Vladimir Aleksandrovich Zboykov, Moscow (RU); Artur Flunovich Gumerov, Moscow (RU)

(72) Inventor: Vladimir Aleksandrovich Zboykov, Moscow (RU)

(21) Appl. No.: 17/070,980

(22) Filed: Oct. 15, 2020

(30) Foreign Application Priority Data
Oct. 18, 2019 (RU) 2019133192

(51) Int. Cl. B64C 37/00; B60F 5/02

(52) U.S. Cl. CPC B64C 37/00; B64C 2211/00; B60F 5/02

(57) ABSTRACT

The invention relates to multifunctional transport equipment, in particular to the field of a combination of technical means for movement on the ground with an aircraft structure, a result of which the connected devices are capable of flying as a whole. A composite flying vehicle developed that combines a land wheeled vehicle with a removable aircraft portion, having at least a system for connecting with the land wheeled vehicle. The system of connection provide the mechanical connection of the removable aircraft portion with the land wheeled vehicle by fastening the rotatable docking units to disks and/or with the hubs of automobile wheels, and transmission of torque from the drive wheels to the propellers of the removable aircraft, thereby creating thrust. The claimed invention provides along the possibility of using a mass-produced automobile in the composite flying vehicle, which reduces the cost of manufacturing and operation of a composite flying vehicle.

### TECHNICAL FIELD

The invention relates to multifunctional vehicle, in particular, to the field of vehicle for use on the land (for example, an automobile) with a removable aircraft portion (for example, a glider), as a result of which the connected unit are capable to fly as a whole.

### BACKGROUND OF THE INVENTION

Attempts to create and commission the so-called “flying cars” or “autoplanes” have a long history from the beginning of the 20th century.

Such attempts have been made many times by automobile manufacturers (for example, Ford—«Sky Flivver» (publ. 1926), Chrysler—«VZ-6CH» (publ. 1957), www.roadabletimes.com, Toyota—Japanese invention JP2005125976 (publ. May 19, 2005), Kawasaki—Japanese invention JPS63130413 (publ. Jun. 2, 1988), BMW—Germany invention DE10215176 (publ. Oct. 30, 2003) and DE10159082 (publ. Jun. 12, 2003), Daimler-Benz AG—PARAT-Studie 1990-Personal Advanced Road Air Transportation and other. Many patents from aviation companies are known: Boeing—www.roadabletimes.com, Messerschmitt MBB—Kyrill von Gersdorf: “Ludwig Bolkow and sein Werk-Ottobrunner Innovationen” Bernhard & Graefe Verlag, publ. 1987; McDonnell Douglas—USA invention U.S. Pat. No. 5,915,649 (publ. Jun. 29, 1999), Lockheed—USA invention U.S. Pat. No. 2,762,584 (publ. Sep. 11, 1956) and other).

A large number of patents are known in which the designs of “flying cars” are considered, which are docked for the duration of the flight, a specialized (i.e., specially designed) land vehicle and specially developed aircraft portion, in most cases having wings, a tail unit and one or two own engine with propellers.

Are known a number of patents that only conditionally unite automobile with aircraft, in which the automobile is actually just a place to accommodate the crew, equipped with aircraft controls in flight. For example, in US patent U.S. Pat. No. 2,410,234 (publ. Oct. 29, 1946), which discloses a light two-seater land vehicle, which drives into an almost empty fuselage of an aircraft resembling a cargo hold, is fixed in it, is connected to the systems of this aircraft and thus performs the role of the “mobile cockpit” of the pilot. In fact, in this patent, the land vehicle is simply transported by aircraft in its fuselage, having an additional function, therefore such a combination of devices cannot be called a “flying car”.

In a number of other patents, the combination of a land vehicle and a removable aircraft portion for their joint flight is more integrated.

For example, U.S. Pat. No. 2,562,491 (publ. Jul. 31, 1951), which discloses the design of a specially designed very light, albeit low-power, but full-fledged for road operation of a automotive unit, the roof of which has the possibility of an uncomplicated mechanical connection for the duration of the flight with an flight unit. Includes all elements, including the power plant, the propeller driven by it, instruments and flight controls. The flight unit portion itself not investigated in the patent.

As a component of the complex for the implementation of the flight, the automotive unit during the flight is useless weight—the road engine and the fuel tank, which not used, while the flight unit of the structure contains its own engine, which also makes it more expensive.

Also known US patent document US2011163197 (published Jul. 7, 2011), which discloses a flight unit, where a road vehicle with single-file seating with a motorcycle landing of the driver and passenger “one after the other” for the duration of the flight is quickly joined by an flight unit of a joint design. In part, a motorcycle with a cabin is described, which attached to an aviation one during the flight.

The road vehicle and the flight unit of the patent US2011163197 have their own engines. At the same time, a land vehicle, during its use on the ground, does not carry any elements necessary for flight, due to which it has high maneuverability and small dimensions when operating on the road and when parking. The road vehicle according to the patent is very light, therefore it provides for the possibility for the driver to stick his legs out of the cab through special openings in the floor that are open during parking, and during a stop with his feet, keep the vehicle in an upright position. The patent US2011163197 provides for the possibility of using a variety of flight units—from an aircraft type with a pushing propeller, to a gyroplane and even a helicopter, and the versatility of using different types of aircraft units with the same light two-seater vehicle is represented by the patent as its special advantage. Moreover, all instruments and flight controls are concentrated in a land vehicle.

The disadvantage of the solution according to US2011163197 is the emphasis not on the versatility of the flight unit and the possibility of using a mass-produced car (or, as in this case, a motorcycle) as such, but the emphasis on the versatility of the possibility of using various flight unit with a particular considered land vehicle. All this does not help to reduce the cost of the proposed combined design as a whole, since it does not provide for the use of standard components used by most of their owners on a daily basis (such as a personal a mass-produced car). In addition, the combined design according to US20110163197 requires appropriate tolerances and pilot skills in flight operation to control it, which sharply limits the potential range of users, and the presence of its own engine in the aviation unit makes it impossible to have a low level of its cost.

The closest analogue of the claimed invention is a combined land and air vehicle according to U.S. Pat. No. 3,645,474 (publ. Feb. 29, 1972). The patent contains a composite vehicle including an automobile for driving on the ground and a removable air structure. Moreover, to use the proposed ordinary serial land automobile, specially prepared and fastened to the air portion for the upper part of the car roof. The air structure includes wings, a tail unit, and an aircraft engine. The U.S. Pat. No. 3,645,474 provides for the presence of a system for transmitting energy from a car engine through a connecting shaft with an overrunning clutch specially installed on the automobile, connected on the one hand to the propeller shaft or transmission shaft of the automobile, and on the other to the propeller of the air engine. An automobile engine has the ability to rotate a propeller, but only in emergency cases when an aircraft engine fails. Such a solution is inevitable in the conditions of low power of an automobile engine and a relatively large mass of a vehicle provided for by the patent.

To control the flight of a composite vehicle according to patent U.S. Pat. No. 3,645,474, it envisaged to equip the passenger compartment with manual control with preliminary disconnection of the steering wheel from the front automobile wheels and with connecting it to the elevator controls and ailerons of the aircraft portion. As well as alterations of the pedal control to switch them from the function of movement on the ground and flight control functions. At the same time, all devices necessary for the flight are also in the passenger compartment.

Thus, the goal in patent U.S. Pat. No. 3,645,474 of creating combined land and air vehicle while minimizing the cost of its production was not fully solved, since although the patent provided for the use of a production car, nevertheless, it had to undergo serious retrofitting and factory alteration of mechanical units to meet the requirements of the patent. But the main thing is that the air structure contained a part that greatly increased its cost—its own aircraft engine. The use of this compound vehicle only by a trained pilot, as all flight control carried out under the patent from the passenger compartment in manual mode. Also, fastening the vehicle to the air structure by means of the vehicle body structure carries risks of separation of the vehicle from the aerial structure in flight and during takeoff and landing.

Consequently, one of the main unresolved problems of creating systems “land automobile-air flying vehicle” is the economic feasibility of this type of transport. The use of a mass road automobile as a passenger capsule of a flying vehicle instead of specialized structures for movement on the ground as part of combined air-ground vehicles is an effective way to reduce the cost of systems as a whole. Combined flying vehicle that are currently being created and previously created provide for the use of actually specially designed (and therefore small-scale and excessively expensive) automobiles, initially considered as a component of such a flying vehicle.

### BRIEF SUMMARY OF THE INVENTION

The main objective of the invention is to develop a composite flying vehicle, in which due to the unusual connection of a removable aircraft portion with a land wheeled vehicle, an increase in the reliability of fastening, a simplification and acceleration of such fastening will provided. Most importantly, to reduce the cost of a composite flying vehicle as a whole, it will provided the possibility of using conventional automobiles of serial production, instead of specially created road vehicles.

Additionally, to facilitate the technical result to overall composite flying vehicle, as well as to reduce its cost, the task was to use the power engine of an automobile both for movement on the ground and for flight.

A composite flying vehicle has been developed, which combines a land wheeled vehicle, powered and normally designed for ground travel, equipped with a removable aircraft portion, usually without a power engine, but having wings, a tail unit, at least two movers (propellers), a flight control unit, and a system for connecting to an automobile. The system of connecting the aircraft portion with an automobile usually includes four docking assemblies (but not less than two), installed with the possibility of rotation in bearings placed on the rack-chassis. The system of connecting providing both a mechanical connection of the removable aircraft portion with an automobile by fastening the docking assemblies to the disks and/or the hubs of its wheels, as well as the transmission of torque of the drive wheels to the propellers of the removable aircraft portion, creating thrust.

According to the invention, the aircraft portion-to-automobile connection system typically includes four docking assemblies connecting the aircraft portion to each of the four wheels of the automobile. The docking units of the removable aircraft portion, rotating in bearings, are fastened to the disks and/or wheel hubs of the automobile, and at two or four docking units from the engine of the automobile through two or four drive wheels, the torque to create thrust is transmitted to the propellers of the removable aircraft portion. The use of an automobile with a removable aircraft portion that does not have its own engine, lightens and reduces the cost of a composite flying vehicle. The high reliability of the connection of the removable the aircraft portion with the land wheeled vehicle, as well as the simplification and increase in the speed of such connection, ensured by using the proposed connection system, which includes at least two docking units (usually four docking units) with the possibility of connecting them to the discs and/or hubs of the wheels of a land wheeled vehicle, as well as transmitting torque from the power plant of the land wheeled vehicle through drive wheels to the propellers of the removable aircraft portion. This connection system also enables the use of mass-produced land wheeled vehicles, for composite flying vehicle instead of specialized vehicle and provides the versatility of the removable aircraft portion with respect to the brands and models of the automobiles used in conjunction with it. This design also minimizes the cost of the composite flying vehicle as a whole and simplifies its manufacture.

According to a preferred embodiment of the present invention, the mechanical connection of the removable aircraft portion with the automobile is the connection of the end flange of each of the four docking assemblies rotating in the journal bearings of the four struts that used as the rack-chassis of the composite flying vehicle. In this case, the end flange of the docking unit can be attached either directly to the wheel hub unit (using bolts passing through the wheel disk, or using nuts if the wheel hub unit is equipped with studs). In another mechanical way, fastening the end flange of the docking unit can carried out to a specialized wheel disc.

The transfer of torque from the drive wheels of the automobile to the movers (propellers) of the removable aircraft portion carried out by a mechanical connection of the end flange of the docking unit connected to the drive wheel of the land wheeled vehicle with the movers (propeller) of the aircraft portion. For example, through a flexible shaft that coaxially passes through the drive wheel mating assembly. At the same time, flexible shafts coaxially pass through the docking assemblies of the drive wheels, by means of which the torque transferred from the drive wheels of the automobile to the movers (propellers) of the removable aircraft portion. That create thrust, ensuring that the rotational speed of the propellers and the rotational speed of the drive wheels of the automobile.

Using a flexible shaft to transfer torque from the drive wheels to the movers (propellers) to create thrust is not the only way, but is the preferred. Instead of a flexible shaft for transmitting torque from the drive wheels of the land vehicle to the propellers of the removable aircraft portion many other mechanical torque transmitting device may be used, including the use of the devices with converting rotation frequency (reduction).

The system for connecting the removable aircraft portion with an automobile preferably includes four rack-chassis, in the power bearings of which rotating docking assemblies are fixed. At least two of which are active—they attached to the disks and/or hubs of the drive wheels, transmitting torques to the movers (propellers), and the rest of the struts-landing are equipped with a passive docking unit only for connecting to the disks and/or hubs of the non-drive wheels of the automobile.

In a preferred embodiment, the removable aircraft portion is a frame structure on which the wings, the tail unit and four struts-landings. Struts-landings movably fixed with the possibility of their longitudinal movement and reliable fixation in the given places of the frame in accordance with the size of the wheelbase of the automobile, which are used. Such a preferred design of the rack-chassis system with a frame provides the possibility of longitudinal balance of the removable aircraft portion assembly, the versatility of the detachable aircraft portion, its ability to attach to mass-produced automobiles of various models from different brands, with a different wheelbase, track width, etc. In this case, rack-chassis made by changing their length and configuration.

An automobile used in a composite flying vehicle, mainly considered as a mass-produced vehicle, but it must be equipped with an on-board computer. This computer must be equipped with special software that allows automatic control (without the participation of the driver) of all major automobile components and functions (turning on/off the automobile engine, engine speed, other engine parameters, brake control, locking the front wheels, etc.). The presence of an on-board computer in an automobile is necessary to ensure the control and safety of the flight of a composite flying vehicle with full control of its flight according to the flight program and/or under control from the airport services, without the participation of persons in the land wheeled vehicle during the flight.

The power plant of an automobile may be combustion engine or an electric motor (electric motors), or another power unit that drives the driving wheels of an automobile in rotation in its ground mode of use.

The removable aircraft portion is equipped with a flight control unit equipped with a flight control computer, its executive bodies, including control units for the drives of the wing and tail empennage, radar station, navigation devices, measuring equipment and other devices, necessary for the flight of a composite flying vehicle. A wireless (preferably) connection must be provided between the flight control computer of the removable aircraft portion and the on-board computer of the automobile, which makes it possible to control from the main components of the land wheeled vehicle, including control of starting and modes of its engine, brakes, locking the steering wheel, doors and trunk, and other systems.

The flight control unit of the removable aircraft portion should preferably contain its own battery source of electrical energy for operating the entire on-board equipment of the removable aircraft portion. The above-described implementation of the composite flying vehicle allows for the flight in full autopilot mode.

The removable aircraft portion may have two or four pulling and/or pushing propellers that generate thrust. The propellers loosely fixed in rotation bearings on the frame or wings of the removable aircraft portion. The number of propellers of the removable aircraft portion should preferably be the same as the number of drive wheels of the automobile used.

The removable aircraft portion usually does not have its own power engine. Allowed equip the removable aircraft portion with its own reserve (emergency) power engine capable of rotating propellers to create thrust in emergency case for increase the safety of the composite flying vehicle as a whole.

### BRIEF DESCRIPTION OF THE SEVERAL VIEWS OF THE DRAWING

The claimed invention illustrated using the following figures:

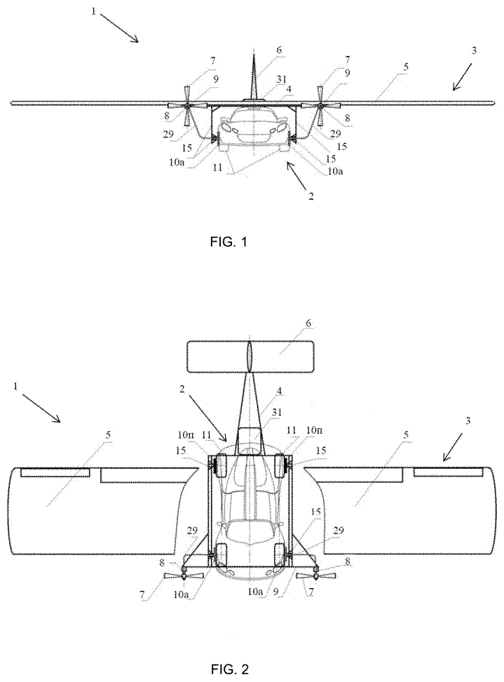

in FIG. 1 is a schematic front view of a composite flying vehicle in an integration embodiment a front wheels drive automobile with the removable aircraft portion with pair pulling propellers, version using flexible shafts to transmit torque;

in FIG. 2 is a schematic top view of the composite flying vehicle of FIG. 1;

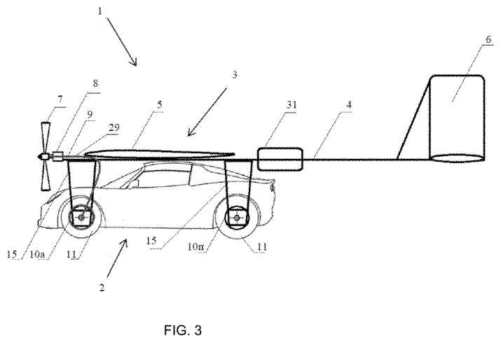

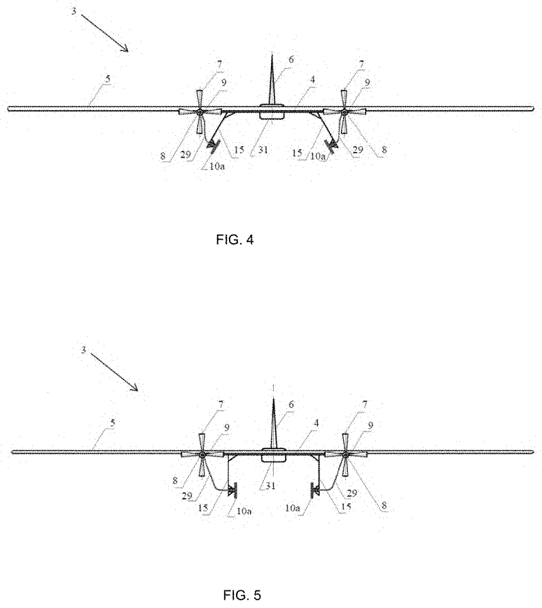

in FIG. 3 is a schematic side view of the composite flying vehicle of FIG. 1;

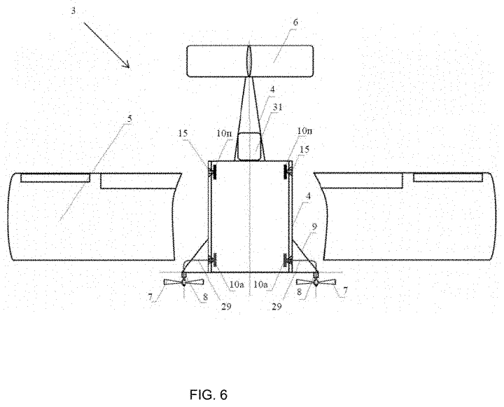

in FIG. 4 is a schematic front view of a composite flying vehicle of FIG. 1 with the position of the rack-chassis corresponding to the separation of the removable aircraft portion and the automobile;

in FIG. 5 is a schematic front view of a composite flying vehicle of FIG. 1 with the position of the rack-chassis corresponding to the integration of the removable aircraft portion and the automobile;

in FIG. 6 is a schematic top view of the removable aircraft portion for composite flying vehicle of FIG. 2;

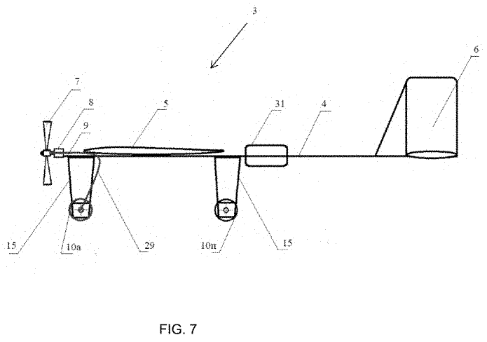

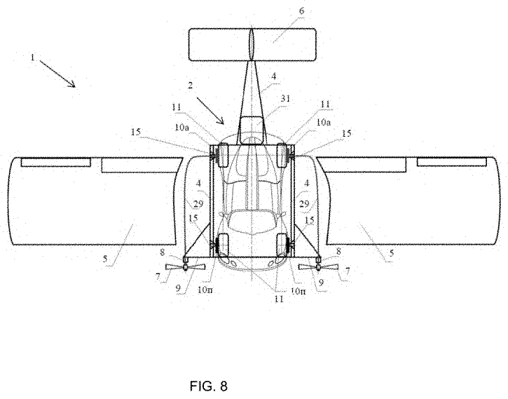

in FIG. 7 is a schematic side view of the removable aircraft portion for composite flying vehicle of FIG. 3;

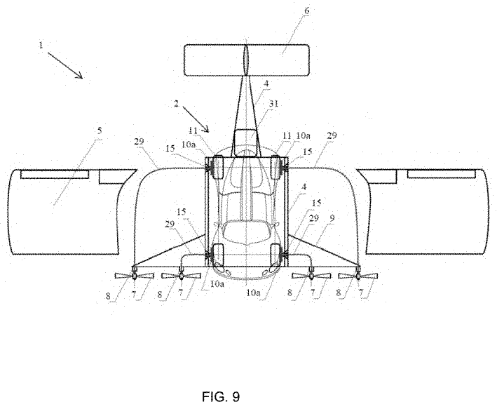

in FIG. 8 is a schematic top view of a composite flying vehicle in an integration embodiment a rear-wheels drive automobile with the removable aircraft portion with pair pulling propellers, version using flexible shafts to transmit torque;

in FIG. 9 is a schematic top view of a composite flying vehicle in an integration embodiment a four-wheels drive automobile with the removable aircraft portion with two pair pulling propellers, version using flexible shafts to transmit torque;

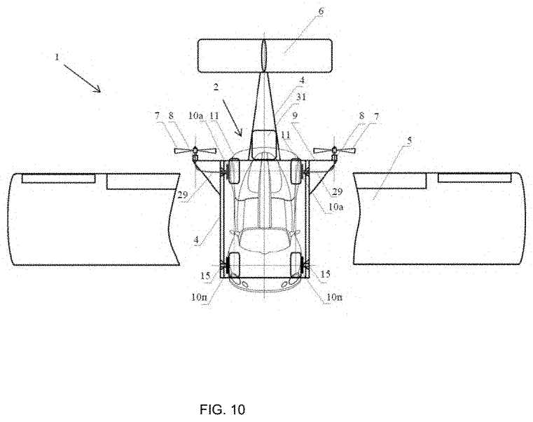

in FIG. 10 is a schematic top view of a composite flying vehicle in an integration embodiment a rear-wheels drive automobile with the removable aircraft portion with pair push propellers, version using flexible shafts to transmit torque;

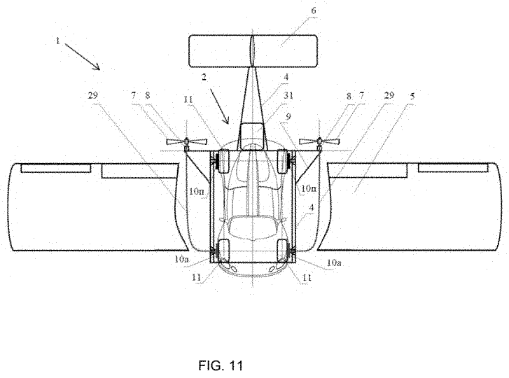

in FIG. 11 is a schematic top view of a composite flying vehicle in an integration embodiment a front wheels drive automobile with the removable aircraft portion with pair push propellers, version using flexible shafts to transmit torque;

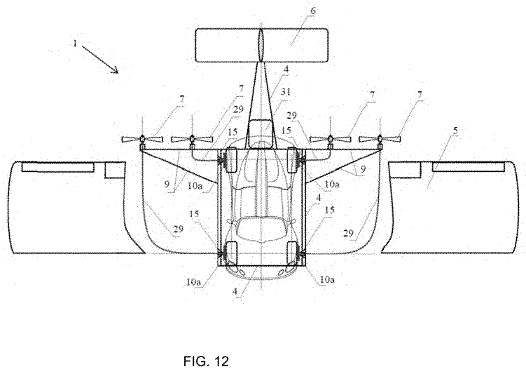

in FIG. 12 is a schematic top view of a composite flying vehicle in an integration embodiment a four-wheels drive automobile with the removable aircraft portion with two pair push propellers, version using flexible shafts to transmit torque;

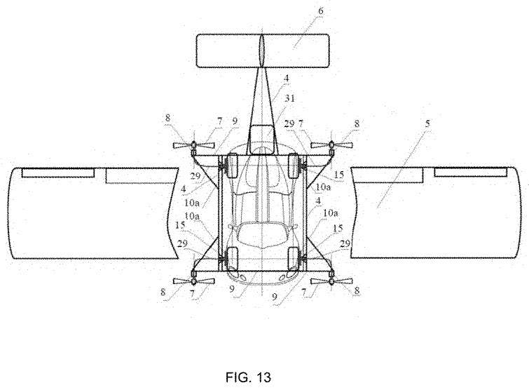

in FIG. 13 is a schematic top view of a composite flying vehicle in an integration embodiment a four-wheels drive automobile with the removable aircraft portion with pair pulling and pair push propellers, version using flexible shafts to transmit torque;

in FIG. 14 shows a block diagram (functional units) of the connection of the drive wheel of an automobile with the removable aircraft portion and with transmit of torque from the wheel hub assembly to the pulling or pushing propeller by using flexible shafts to transmit torque;

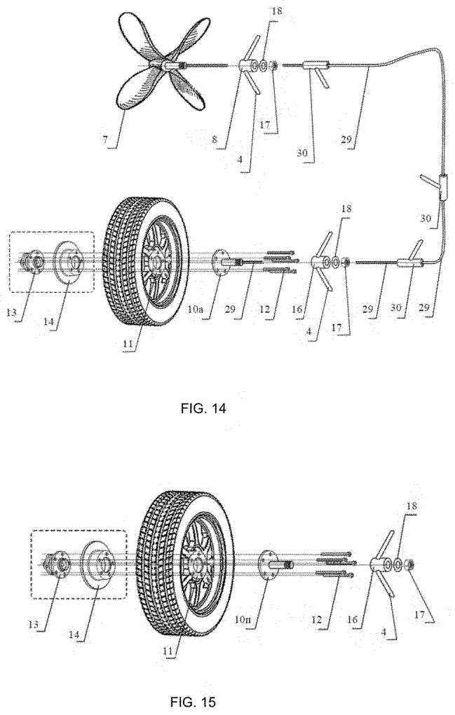

in FIG. 15 shows a block diagram (functional units) of connection of a non-drive wheel of an automobile with the removable aircraft portion;

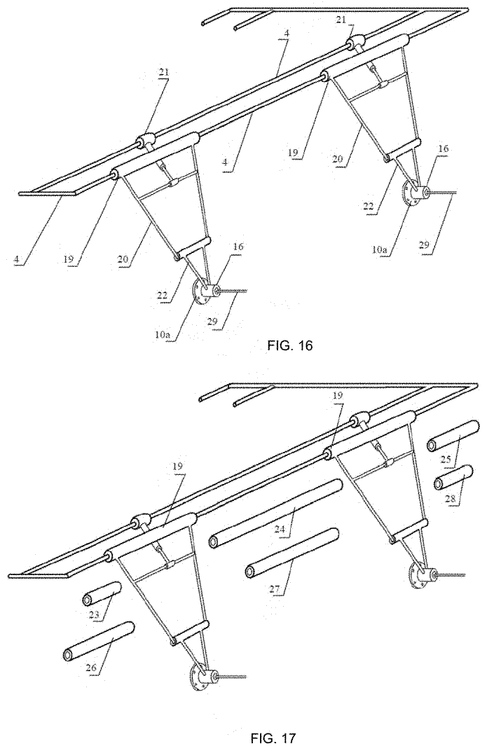

in FIG. 16 shows a block diagram (functional units) of a variant of connecting rack-chassis with a frame of the removable aircraft portion in an embodiment using of an automobile with four-wheels drive using four active docking units of rack-chassis and flexible shafts to transmit torque;

in FIG. 17 shows a block diagram (functional units) of a technical solution for adapting the frame structure of the removable aircraft portion for joint use with automobiles of various brands and models differing in wheelbase size using flexible shafts to transmit torque.

The following is a list of items shown in FIGS. 1-17:

1—composite flying vehicle (CFV);

2—land wheeled vehicle (automobile);

3—removable aircraft portion;

4—frame;

5—wings;

6—tail unit;

7—propeller;

8—propeller bearing;

9—frame console;

10—docking unit, where 10a—active docking unit; 10n—passive docking unit;

11—wheel;

12—bolt for fastening the docking unit;

13—hub (hub assembly component);

14—brake disc (hub assembly component);

15—rack-chassis;

16—power bearing of the rack-chassis;

17—nut;

18—washer;

19—pipe in the upper part of the rack-chassis 15, providing mobility of the rack-chassis in relation to the frame;

20—middle part of the rack-chassis 15;

21—tube of the telescopic holder of the rack-chassis 15 in the required position;

22—lower movable part of the rack-chassis 15;

23—spacer pipe for the conditionally front part of the frame 4 when using the automobile “A”;

24—spacer pipe for the conditionally middle part of the frame 4 when using the automobile “A”;

25—spacer pipe for the conditionally rear part of the frame 4 when using the automobile “A”;

26—spacer pipe for the conditionally front part of the frame 4 when using the automobile “B”;

27—spacer pipe for the conditionally middle part of the frame 4 when using the automobile “B”;

28—spacer pipe for the conditionally rear part of the frame 4 when using the automobile “B”;

29—flexible shaft;

30—flexible shaft guide;

31—flight control unit as part of the removable aircraft portion.

### DETAILED DESCRIPTION OF THE INVENTION

As shown in FIG. 1-13, a composite flying vehicle (CFV) 1 integrated a land wheeled vehicle 2 equipped with a powerful engine (not shown) with the removable aircraft portion 3.

In a preferred embodiment of the present invention, into a single whole are combined an automobile (for use as a passenger or cargo capsule and a power unit of a composite flying vehicle) and the removable aircraft portion. The removable aircraft portion is universal with respect to the cars of various brands and models in conjunction with it (but satisfying the boundary requirements for providing energy performance, safety, etc.). At the same time, a person skilled in the art will understand that as land wheeled vehicle suitable for these purposes can be used any other wheeled vehicle. However, hereinafter, as an illustrative example, the structure of the CFV including the car automobile as a land wheeled vehicle 2 will described.

The following minimum requirements imposed on the automobile used as part of the claimed CFV:

high power-to-weight ratio sufficient to ensure the takeoff and flight of the CFV, i.e. the ratio of the mass of the automobile to the power of its engine, which approximately should not exceed 3 . . . 5 kg/hp;

in the automobile must be an on-board computer, which can to control of the operation and diagnostics of the state of all main systems of the automobile, including the engine (the ability to control the launch of the engine and setting and maintaining its operating modes), collecting data on fuel consumption (or battery charge for an electric vehicle), as well as controlling the brakes, fixing in a certain position the front wheels of the automobile, etc.;

it should be possible to control the distribution of traction forces (torques) between the drive wheels by the commands of the on-board computer;

it should be possible to remotely exchange a commands between the on-board computer of the automobile and the computer from the control unit of the removable aircraft portion;

if the automobile has a rear wing, it must be able to be disconnected or be able to block its raising from the on-board computer;

ability to block the opening of doors, hood and trunk of the automobile by commands from the on-board computer.

It is highly desirable that the automobile used as part of the CFV has:

reinforced suspension, powerful shock absorbers on all wheels;

aerodynamic body shape, which is the least pressing the automobile to the road surface while driving on the ground;

low the center of gravity.

it is good if the power plant of the automobile consists of two or four electric motors driving each of the two or four wheels of the automobiles (the so-called motor-wheels).

To use an automobile as part of the CFV, it is preferable significantly to strengthen its suspension, because at moment of touching the runway of a certain force, overload is inevitable. Reducing the overload at moment of touching the runway ensured by achieving a smooth automatically controlled landing of the CFV, optimal operation of the entire complex, detachable aircraft 3-flight control unit 31-CFV as a whole, nevertheless, the shock loads will be quite large.

Special for use an automobile as part of the CFV can to be developed and mass-produced special rims. Such rims must be adapted for a convenient and reliable connection with the docking unit 10 of the removable aircraft portion 3 either directly with the wheel disks or through the wheel disks with wheel hub assemblies.

Also automobile manufacturers or other companies (for example, those producing the aircraft portion) must develop special software for the automobile computer, use in conjunction with the flight control unit 31 as part of the CFV (this software must be approved (certified) by a special department responsible for the safety of air transportation).

Obviously, automobiles recognized as suitable for use as part of the CFV, must receive an official confirmation of suitability (certificate or other document), which gives permission for their use as part of the CFV.

The removable aircraft portion 3 is a specially designed device for this purpose—is a glider, similar to the glider of a light aircraft. The design of the removable aircraft portion 3, used as part of the CFV, must be lightweight.

The role of the usual volumetric airframe of the removable aircraft portion, performed by the frame 4, which has a frame structure. Frame 4 can be made of aluminum, titanium, chromium-molybdenum, carbon fiber, carbon pipes, any lightweight and strong materials. The tubular structure of the frame 4 of the removable aircraft portion 3 looks the most optimal, although can also be made from other profile made of the same materials.

The removable aircraft portion 3 necessarily has wings 5 fixed on the frame 4, the tail unit 6 with the necessary mechanization and two or four propellers 7.

The wings 5 of the removable aircraft portion 3 are equipped with mechanization (flaps, ailerons) with electric drive mechanisms built into the wing. In FIGS. 1-13 the removable aircraft portion 3 is show with a straight wing, as the most suitable for ensuring the minimum take-off speed of the CFV, while the wing can be of a different configuration. There should be provision for the placement of luminous devices on the wings—standard flight lights.

In FIGS. 1-13 the removable aircraft portion 3 is shown with a tail unit 6 including one vertically located keel and a horizontal stabilizer, however, a detachable aircraft 3 may contain two keels.

The drive devices 7 of the removable aircraft portion 3 are pulling and/or pushing propellers, where the number of propellers of the removable aircraft portion 3 is preferably equal to the number of drive wheels of automobile 2.

Thus, the removable aircraft portion 3 can to contain only two propellers (as shown in FIGS. 1-8, 10-11 for a vehicle with only forward or only rear wheel drive). Or to contain four propellers (as shown in FIGS. 9, 12 and 13 for an all-wheel drive vehicle), where two propellers can to be pulling, and two-pushing, or all four propellers can to be pulling or pushing.

The propellers of the removable aircraft portion 3, which create thrust, rotate freely in the propeller bearings 8, fixed on the frame 4 or on the wings 5, driven in rotation from the automobile's engine. In the variants shown in FIG. 1-13, bearings 8 fixed on a special console 9 of the frame 4, but they can installed directly on the wing 5 of the removable aircraft portion 3. In this case, the console 9 of the frame 4 is an optional unit in the case of fastening the bearings 8 of the propellers on the wing 5 of the removable aircraft portion 3.

The removable aircraft portion 3 contains a system for connecting to the automobile 2, which includes a four docking units 10. The docking units 10 made with the possibility of connecting to the disks and/or the wheel hubs 11 of the automobile 2, as well as for transmitting torques from the engine of the automobile 2 through its drive wheels to the propellers 7 of the removable aircraft portion 3. In the figures, the docking units 10 denoted by the letter “a” (active docking unit) or by the letter “n” (passive docking unit), depending on whether it is connected to the disks and/or hubs of the drive wheels or non-drive wheels. In the text uses the designation of the docking units by position 10 without a letter, if we are talking about any docking units, active or passive. The docking station designation 10a or 10n when it comes to active or passive docking units only.

In FIG. 14 and FIG. 15 show the bolts 12 for fastening the docking unit 10 to the wheel hub 11 of the automobile, or fastening to the specialized disc of the wheel 11 of the automobile. If the wheel hubs 11 are equipped with studs, nuts used instead of bolts. Automobile wheels can used with both specialized and conventional disks, to which (or through which) the docking unit 10 rigidly attached. Components 13 and 14 of the wheel hub 11 of the automobile (hub, brake disc) are not fundamental elements for ensuring the functioning of this solution (fastening of the docking unit 10 can be carried out to a specialized wheel rim 11 of the automobile) and given for clarity.

The connection of the wheels 11 with the docking units 10 and the transfer of torque from the drive wheels carried out by coaxially attaching the flange of the docking units 10 to the disks of the wheel through the standard holes for fastening the disks of the wheels 11 to the hubs unit by extended bolts 12. Also the connection of the wheels 11 with the docking units 10 and the transfer of torque from the drive wheels may by coaxially attaching the flange of the docking units 10 to the specialized wheel disks 11 and fastening directly to it (using bolts 12 or nuts). When using specialized wheel disks 11, having a special threaded hole (or a stud) in the center, the connection of the docking units 10 with specialized wheel disks 11 can be carried out at one point, in the center of the disk, by screwing along the thread (in the direction opposite to the direction of rotation of the wheels 11, when an automobile is moving forward).

The system of connecting the removable aircraft portion 3 with the automobile includes four rack-chassis 15, in the power bearings 16 of which rotatably installed the docking units 10, at least two of which are active docking units 10a for connection with the disk and/or the hub of the drive wheel 11 and the transmission of torque, and the rest are passive docking units 10n for connection with the disk and/or the hub of the non-drive wheel 11. The rack-chassis 15 perform the role of a landing gear for the removable aircraft portion 3 by mechanical connection of the frame 4 with the docking units 10 through the power bearings 16.

It is preferable to provide for the possibility of changing the length and configuration of each rack-chassis 15. In FIGS. 1-13 shows variants of the rack-chassis 15 of the deviating type, (the removable aircraft portion 3 and the automobile disconnected after set aside of the docking unis 10 from the disks and/or hubs wheels 11 of the automobile, FIG. 4). It is preferable to provide for the possibility of changing the length and configuration of each rack-chassis 15. However, the design of the rack-chassis 15 can to make in a different way, which does not affect the essence of the present technical solution.

Pos. 17 and 18 in FIGS. 14 and 15 denote a nut and a washer, respectively, serving to retain the docking units 10 in the power bearings 16 of the rack-chassis 15. The nut 17 and the washer 18 are not functionally important elements and shown in FIGS. 14 and 15 of the connection of the disc and/or wheel hub 11 of the automobile with the rack-chassis, as well as the propeller with the bearing 8 for clarity only. These elements can replaced by others, which ensure the retention of the rods of the docking units 10 in the power bearings 16 of the rack-chassis 15, as well as the rods of the propellers in the bearings 8. In this case, the rods of the docking units 10 and the propellers may not have an external thread, but be pressed into the bearings, respectively.

In FIG. 16 shows a block diagram of functional units of one of the possible technical solutions for connecting the rack-chassis 15 with a tubular frame 4 in the variant of using an automobile with all-wheel drive 11 (i.e. using four active docking units 10a with rack-chassis 15). Pos. 19 to 22 in FIG. 16 denotes the functional components of four identical rack-chassis 15 with the active docking units 10a, where 19 denotes the pipe of the upper part of the rack-chassis 15, movably coaxially put on the tubular longitudinal part of the frame 4 of the removable aircraft portion 3. This is necessary for serving to ensure the retention automobile by the removable aircraft portion 3 of the (wheels 11 holding), for deflection of the rack-chassis 15 (retraction from the wheel 11 of the automobile) for fixing/detaching the docking unit 10 from the disk and/or the hub of the wheel 11. The position 20 denotes the middle part of the rack-chassis 15, to which the telescopic holder of the rack-chassis 15 attached at one end in the working or in the retracted position (with respect to the wheels 11 of the automobile). Position 21 designates the telescopic holder of the rack-chassis 15, movably coaxially put on the tubular longitudinal part of the frame 4 of the removable aircraft portion 3, where the telescopic holder of the rack-chassis 15 serves to hold the rack-chassis 15 in the working or retracted position in relation to the wheels 11 of the automobile). The position 22 denotes the lower movable part of the rack-chassis 15, in which the power bearings 16 of the rack-chassis 15 is fixed, in which the docking units 10 rotates.

To adapt the removable aircraft portion 3 for joint use with automobiles of various brands and different models with different wheelbases, track widths, as well as different mode of wheel disks, different the location of rack-chassis 15 along the frame 4, different the distance between them, as well as the distance between the docking units 10 for each pair of wheels 11 of the automobile, the following next technical solutions can be used:

for the different size of the wheelbase and track width of the automobile of each of the possible models or brands, used in CFV, used a special separate version (modification) of the frame 4 and the rack-chassis 15;

for all automobiles used in CFV, the same frame 4 is used, but there is a choice of replaceable assemblies (elements) in such a way that for each of the possible wheelbase sizes and track widths of the automobile used the frame 4 is adapted by installing replaceable units (elements) on it, adapted to a certain size of the wheelbase and track width of the automobile used;

for all automobiles used in CFV, the same frame 4 and chassis 15 are used, while the distance between the working position of the pairs of docking units 10 is set using additional mechanization of the frame 4 and rack-chassis 15.

In FIG. 17 shows a block diagram of the functional units of the technical solution for adapting the frame 4 for joint use with automobiles of various brands and models having different wheelbases by installing interchangeable units on the frame 4 of—flying vehicle 3—spacer pipes of different lengths, adapted to the size of the wheelbase of different automobiles. Position 23 in FIG. 17 denotes a spacer pipe for the conditionally front part of the frame 4, which acts as a spacer between the front end of the frame 4 and the upper part (in the form of a pipe) 19 of front rack-chassis 15 when using the automobile “A”. Position 24 denotes a spacer pipe for the conditionally middle part of the frame 4, which acts as a spacer between the front and rear upper part (in the form of a pipe) 19 of rack-chassis 15 when using the automobile “A”. Position 25 denotes a spacer pipe for the conditionally rear part of the frame 4, which acts as a spacer between the rear end of the frame 4 and the rear upper part (in the form of a pipe) 19 of rack-chassis 15 when using the automobile “A”. Position 26 denotes a spacer pipe for the conditionally rear part of the frame 4, which acts as a spacer between the front end of the frame 4 and the front pillar upper part (in the form of a pipe) 19 of rack-chassis 15 when using the automobile “B”. Position 27 denotes a spacer pipe for the conditionally middle part of the frame 4, which acts as a spacer between the front and rear upper part (in the form of a pipe) 19 of rack-chassis 15 when using the automobile “B”. Position 28 denotes a spacer pipe for the conditionally rear part of the frame 4, which acts as a spacer between the rear end of the frame 4 and the rear upper part (in the form of a pipe) 19 of rack-chassis 15 when using the automobile

The essence of the technical solution in FIG. 17 is that the sum of the length of the two upper parts 19 (in the form of a pipes) of the front and rear rack-chassis 15 together with three spacer pipes (23, 24, 25 or 26, 27, 28) must exactly match the longitudinal length of the tube of the frame 4. Thus, spacer pipes installed on the left and right longitudinal parts of the frame 4, in the amount corresponding to the wheelbase of a particular automobile.

Is possible to shift the position of the automobile along the frame 4 of the composite flying vehicle 3 (with a fixed length of pipes of the upper part of the two rack-chassis 15 and a fixed wheelbase of the automobile) by varying the proportion of the lengths of the spacer pipes. Thus it is possible to balancing (optimizing the longitudinal position) of the center of gravity of the entire CFV.

For the purpose of adapt removable aircraft portion 3 to automobiles of different brands and manufacturers with differences in the hub and the methods of attaching wheel disks to them, the docking units 10 can be interchangeable (for four or five bolts of fastening the wheel disk of the automobile to the wheel hub, for four or five nuts fastening to the studs of the hub, etc.).

For the purpose of balancing the center of gravity of the CFV and adapting the removable aircraft portion 3 to the brand and model of a particular automobile used, rack-chassis 15, as well as wings 5 and tail unit 6, may be fix in specified places in accordance with the size of the wheelbase of the land wheeled vehicle. For the purpose of adapt to the brand and model of a particular automobile used, its height, width and track size, the rack-chassis 15 have required degree of mobility (the ability to lengthen and bend) with fixing of their length in height above the ground and along the width of the frame 4 as well as configuration. For the purpose of adapt to automobiles that have differences in the hub and the methods of attaching wheel disks to them, the docking units 10 can be interchangeable (for four or five bolts of fastening the wheel disk of the automobile to the wheel hub, for four or five nuts fastening to the studs of the hub, etc.).

The mechanical connection, through which the transmission of torque from the power plant of the automobile 2 through its drive wheels to the movers (propellers) of the removable aircraft 3, is carried out through flexible shafts 29 coaxially attached to the active docking units 10a, ensures compliance the rotation frequency of the propellers of the removable aircraft 3 to the frequency of the drive wheels of the automobile 2.

In FIG. 1-14 shows a technical solution in which the torque from the engine of the automobile transmitted to the propellers of the removable aircraft portion 3 by means of the flexible shafts 29, however, it is possible to use other mechanical devices for transmitting torque, including with a change in the rotational speed. For example, the transfer of the rotation energy of the wheels 11 of the automobile to the propellers of the removable aircraft portion 3 can carried out using transmissions (mechanical devices that provide an adjustable or fixed change of rotational speed of the propellers in relation to the rotational speed of the drive wheels of the automobile).

Flexible shafts 29, used to transmit torque from the drive wheels of the vehicle to the propellers of the removable aircraft 3, perpendicularly connected to the rods pressed into the bearings 8 of the propellers and the bearings 16 of the active docking units 10a. The flexible shaft 29 must fit strictly perpendicular, coaxially to the propeller on one side and to the disk and/or the wheel hub 11 of the automobile on the other side. In one possible embodiment, the flexible shafts 29 enclosed in tubular guides 30 either, along their entire length or only in certain areas. Alternatively, the geometry of the CFV is set such that the use of tubular guides 30 for flexible shafts 29 is not required—the geometry of flexible shafts 29 is set of on the one hand, by the propeller bearings 8, and on the other hand, by the bearings 16 of the docking units.

An automobile 2 should be equipped with an on-board computer (not shown) with the ability to control the main components of the automobile. At the same time, the removable aircraft portion 3 should be equipped with a flight control unit 31 with computer with ability wirelessly communicate with the on-board computer of automobile 2.

The flight control unit 31 necessarily includes a computer and avionics of the CFV (on-board equipment) containing all devices, necessary for the flight, including a radar station, navigation devices, devices for determining the altitude and flight speed, device for wireless communication with the on-board computer of the automobile, device for communication with airport dispatching services for unmanned flight control, devices and mechanisms that provide control of the mechanization of the wings and the tail, other necessary devices that ensure the unmanned operation of the CFV generally. In this case, the flight control unit 31 is equipped with the source of energy (not shown) necessary for the operation of the computer and other electronic equipment of the control unit 31, as well as for activating the mechanization of the wings 5 and the tail unit 6 of the removable aircraft portion 3.

The mechanization of the wings 5 and the tail unit 6 (elevators, ailerons, and so on) of the removable aircraft portion 3, controlled from the flight control unit 31, have autonomous drive motors, the power supply of which is carried out from the electric battery, also located in the flight control unit 31. However, for this purpose, it is possible to use a part of the converted mechanical energy of rotation of the drive wheels of the automobile, which transmitted to an electric generator of the removable aircraft portion by partial extraction of energy by special devices for control of the autonomous drive motors of wing mechanization 5 (wings) and tail unit 6.

During takeoff, flight and landing of the CFV, the software of the flight control unit 31, in interaction with the on-board computer of the automobile, provides blocking of opening of doors and trunk of the automobile, blocking from accidental or intentional impact on the steering wheel and brake pedal of the automobile by passengers, blocking the possibility of any influence of passengers on the engine of the automobile (the possibility of turning it off, changing the task set by the flight control unit 31 for the on-board computer of automobile, operating mode of the engine). The flight control unit 31, through the on-board computer of the automobile, controls the distribution of the torques of each of the drive wheels of the automobile necessary for stable flight, creating individual torques of each propeller through the flexible shaft 29 separately, if necessary, turning off various standard systems that can distribute traction between the driving wheels when driving on the ground (ABS—Anti-Blockier-System, ASR—Antriebs-Schlupf-Regelung, EDS—Elektronische Differentialsperre, ESP—Elektronisches program Stabilitats and others).

The removable aircraft portion 3 may contain additional sources of electrical energy, which may be advisable when using an automobile 2 with electric motors, or additional fuel tanks when using an automobile with an internal combustion engine. In these cases, for the supply of electricity or liquid fuel from energy sources to the power plant of the automobile, an additional connection of these sources with the automobile will be required, which is not desirable. A design that does not use additional energy sources on board the removable aircraft portion used by the automobile's power plant looks preferable.

The removable aircraft portion 3 can also include own power plant, capable of rotating the propellers to create thrust in emergency case (for example, when the engine of the automobile in use fails). However, the presence of its own power plant on the removable aircraft portion is not desirable within the framework of this technical solution.

The application of the invention can be realize in the following practical way.

The practical use of the CFV is to provide the removable aircraft portion in short term rent, for a fully unmanned flight of CFV, under the control of ground control services, on duration of one flight of an automobile with passengers to another airport (or other specialized place), where the lessor's company also operates. Envisaged, that during the flight of the automobile as part of the CFV, the driver of the automobile does not interfere in any way in the flight control, which carried out under the control of the airport dispatch service and the lessor of the removable aircraft portion.

Obviously, it is not economically viable to own the removable aircraft portion that enables the automobile to fly. Since the removable aircraft portion is used only sporadically, it is more expedient, if necessary, to rent it precisely and only for these periods, i.e. for the duration of the flight. In addition, in many of country take-off and landing of flying devices allowed only from specially designated airfields, and the use of public roads or other territories for take-off and landing not allowed. This makes it even less advisable to own the removable aircraft portion that allows the vehicle to fly. In this case, the place of renting the removable aircraft portion for a flight should be the airport or other specially designated and technically equipped sites with runways and airport infrastructure, which host companies that provide the removable aircraft portion for rent.

Step by step, the operation of the CFV (takeoff-flight-landing) may look like this.

1. The automobile arrives at the airport or other location of the removable aircraft portion.

2. The lessor at the airport inspects and tests the automobile for its serviceability and suitability for use in the CFV. It is possible that they check whether the automobile has a certificate of airworthiness or other document confirming the possibility of using this automobile as part of the CFV and its technical serviceability for this purpose.

3. After successful inspects and tests, the automobile combined with the removable aircraft portion 3.

4. The driver sit in the automobile, already integrated with the removable aircraft portion, and drives the CFV to the starting position.

5. The readiness of the CFV for take-off communicated by transmitting a voice or other command from the driver of the automobile to the dispatch center of the airport of departure or to another flight service.

6. Starting from the moment of the transmission of the readiness for take-off message, all control of the CFV completely transferred to the flight control unit 31, located on the removable aircraft portion, and the flight control unit 31 continuously interact with the airport departure and arrival services of CFV.

During take-off, the CFV powered by the automobile's engine, which propels the CFV to lift-off speed. In this case, propellers of the CFV rotate with the speed of the automobile's wheels (if its speed change is not used).

7. During stages of takeoff, flight and landing of the CFV, the flight control unit with the on-board computer of the automobile provides blocking of the doors and trunk of the automobile, blocking the steering wheel and brake pedal of an automobile, and blocking any impact of driver to the engine of the automobile (the ability to turn it off, change the engine operating mode, set by the flight control unit 31). The flight control unit, according to commands of the autopilot program, controls the mechanization of the wings and tail of the removable aircraft portion, providing maneuvering of the CFV in the horizontal plane and in flight altitude, through the transmission of commands to the on-board computer of the automobile provide controls the distribution of the torques of each of the drive wheels of the automobile to generate the same torques for all propellers of the removable aircraft portion.

Also, the flight control unit 31, through the on-board computer of the automobile, controls the torque distribution of each of the drive wheels of the automobile necessary for stable flight—to create the same torques of each propeller, creating through the flexible shaft 29, the torques of each propeller separately. If necessary, disables various standard automobile systems designed to optimally control of the movement and braking of the automobile when it moves on the ground (ABS—Anti-Blockier-System, ASR—Antriebs-Schlupf-Regelung, EDS—Elektronische Differentialsperre, ESP—Elektronisches Stabilitats Programm and others).

The flight control unit receives information about the airspace both from the airport flight services and from the on-board radar station and devises that are part of the flight control unit 31.

8. When landing the CFV, the automobile's engine also controlled by the flight control unit 31 (continuously interacting with the airport arrival service).

At the same time, the flight control unit 31 controls the mechanization of the wings 5 and tail 6 of the removable aircraft portion 3, ensuring the descent and landing of the CFV, giving at the necessary time to the automobile's on-board computer a command to turn on the automobile's brakes. Thus, the braking of the CFV after landing performed by the standard automobile brakes.

In economic terms, the use of the automobile as a passenger capsule in the CFV should not be a priority, because an automobile is a vehicle of road. The possibility of using automobile as a passenger capsule in the CFV should considered as a kind of bonus, as an attractive, but secondary, additional possibility of its operation, which does not lead to a significant increase in the cost of the automobile.

The above-described method of possible practical CFV operation means that for the effective use of the automobile as a CFV passenger capsule, the following technical and organizational conditions must be met:

the minimum necessary revision of the automobile to adapt it for the flight;

CFV operation should be considered exclusively in full autopilot mode (in the absence of a pilot);

rent of the removable aircraft portion is provided directly at the airport of departure and only for the duration of the flight;

it is necessary to organize testing of automobiles for their suitability for operation as part of a CFV with the issuance of appropriate permits;

the connection of the automobile with the removable aircraft portion and the installation check must be carried out by the specialists of the lessor of the removable aircraft portion within a short period (for example, not more than 1 hour in total);

technical and technological support of the CFV autopilot (flight control) during takeoff, during the flight and during landing in the mode at the arrival airport should be provided by airport services and rental companies;

there must be a return to the lessor of the removable aircraft portion at the airport of arrival;

is desirable to guarantee the possibility of the subsequent rental of the removable aircraft portion at the airport of arrival for the possibility of returning to the airport of departure.

Thus, the practical use of the CFV using automobile should include at least:

the possibility of obtaining an airworthiness document (for each individual automobile or for a specific automobile brand, model);

express testing by the lessor of the removable aircraft portion of the technical condition of the automobile for the suitability of the automobile for a safe flight;

the presence of a developed network of airports where lessors provide rental of the removable aircraft portion for use with the automobile during the flight;

availability of support by dispatching services (technical support) of CFV flights from one airport to another along the entire flight path.

At the same time, the complex expediency of using a automobile as a passenger capsule of the CFV is observed only if the following conditions are met:

to be able to use it as a passenger capsule of the CFV, the automobile should not cost much more than the same automobile, but does not have such a function, i.e. it should be a generally ordinary production automobile, only in special modification;

retrofitting of the automobile with devices and software of on-board computer allowing its use as a passenger capsule of the CFV should not require a significant transformation of its design;

integration an automobile with a removable aircraft portion (combining the car with the removable aircraft portion), as well as removal from the automobile of this removable aircraft portion, should be carried out at the airport in a very short time frame, approximately, no more than one hour upon departure and arrival;

the total cost of renting the removable aircraft portion, as well as payment for the services of dispatching services at airports of departure and arrival, support of autopilot in flight, should be lower than the cost of renting a personal business jet or helicopter for a flight in the same period and on the same route;

network of rental services of the removable aircraft portion must be sufficiently developed both for arrival at the required point, and for the absence of a long wait for the lease of a free removable aircraft portion.

The best in terms of ensuring the safety of using an automobile as a passenger capsule of the CFV is the test of the automobile of a particular brand directly at the manufacturing plant with the subsequent receipt of a certain legally significant document of suitability this automobile for use in the CFV (airworthiness of the automobile).

Wherein no special structural changes are required, except for the installation of its on-board computer programs, suspension reinforcement, and, possibly, equipping the automobile with wheels with special disks.

It is advisable to envisage the possibility of using an automobile as a cargo capsule of the CFV. In this embodiment, the automobile will be part of a cargo-CFV (if the automobile does not have an autopilot system for the road). Those in this embodiment, such an automobile during the flight will be an integral part of a cargo drone without passengers.

Thus, the composite flying vehicle has been developed, in which, due to the connection of the removable aircraft portion with the land wheeled vehicle the achievement of the technical result is ensured, which consists in increasing the reliability of fastening the removable aircraft portion to the land wheeled vehicle, simplifying and accelerating such installation, along with the possibility of using a mass-produced ground wheeled vehicle no specialized structures in conjunction with the removable aircraft portion without a power plant, which simplifies and reduces the cost of manufacturing a composite flying vehicle as a whole.

What is claimed is:

1. A composite flying vehicle, containing of a land wheeled vehicle, equipped with power plant, and a removable aircraft portion, including at least two movers, providing traction—a propellers, a wings, a tail empennage, a flight control unit and a system of connecting the removable aircraft portion with the land wheeled vehicle, is characterized in that the system of connecting with the land wheeled vehicle includes at least two a docking units, rotating in bearings on a rack-chassis, by fasten the docking units to automobile disks or hubs of drive wheels provides both a mechanical connection of the removable aircraft with the land wheeled vehicle and transfer of torque of the drive wheels to the propellers, generating thrust.

2. The vehicle according to claim 1, characterized in that the system of connecting of the removable aircraft portion with the land wheeled vehicle includes the four rack-chassis, at least two of which equipped with the active docking units for connecting with drive automobile wheel disks and/or hubs and for transmission of torque from than to the propellers, but the remaining the rack-chassis equipped with the passive docking units attached to disks and/or hubs of non-drive automobile wheels, ensures only fastening to them.

3. The vehicle according to claim 1, characterized in that the movers of the removable aircraft portion are the pulling and/or pushing propellers, moreover the number of propellers of the removable aircraft portion is equal to the number of the drive wheels of land wheeled vehicle used.

4. The vehicle according to claim 1, characterized in that the rotating docking units coaxially through bearings attached the flexible shafts, whereby provide the transfer of torque from the drive wheels of land wheeled vehicle to the movers, generating thrust—the propellers of the removable aircraft portion, by ensuring compliance of the frequency rotation of propellers to the frequency rotation of the drive wheels of the land wheeled vehicle.

5. The vehicle according to claim 1, characterized in that the removable aircraft portion has a carcass, being a frame, on which are fixed the rack-chassis, wings and tail empennage with the possibility of them longitudinal movement along the frame and fixation in specified places, that provides longitudinal balancing of the center of gravity of the composite flying vehicle and adaptation to wheelbase of the land wheeled vehicle.

6. The vehicle according to claim 5, characterized in that the rack-chassis is made with the possibility of changing their length and configuration.

7. The vehicle according to claim 1, characterized in that the removable aircraft portion is equipped of the flight control unit equipped with a flight computer, as well as his a executive devices, including devices to control of the wings mechanization and the tail empennage mechanization of the removable aircraft portion, and also equipped onboard a radar station, a navigation devices and other devices, necessary for the flight of the composite flying vehicle and made with the possibility of a wireless communication of the flight control unit with the on-board computer of the land wheeled vehicle, allowing control a main functions of the land wheeled vehicle, including control of the start and operating modes of its engine, brakes, locking of doors and trunk, locking steering and to control other automobile systems.

8. The vehicle according to claim 1, characterized in that the flight control unit is equipped with a battery-powered or other source of electrical energy for operating all of the onboard equipment of the removable aircraft portion.

9. The vehicle according to claim 1, characterized in that the removable aircraft portion can be supplied of a backup power plant.
